(19) United States
(12) Patent Application Publication
(10) Pub. No.: US 2013/0126160 A1
(43) Pub. Date: May 23, 2013

(54) CROSSLINKED EPOXY VINYL ESTER PARTICLES AND METHODS FOR MAKING AND USING THE SAME

(71) Applicants: Joseph D. Rule, Cottage Grove, MN (US); Kent E. Nielsen, Dorchester (CA); Kevin M. Lewandowski, Inver Grove Heights, MN (US); Mohit Malik, Calgary (CA); Randy Frank, London (CA)

(72) Inventors: Joseph D. Rule, Cottage Grove, MN (US); Kent E. Nielsen, Dorchester (CA); Kevin M. Lewandowski, Inver Grove Heights, MN (US); Mohit Malik, Calgary (CA); Randy Frank, London (CA)

(73) Assignee: 3M INNOVATIVE PROPERTIES COMPANY, St. Paul, MN (US)

(21) Appl. No.: 13/812,984

(22) PCT Filed: Jul. 27, 2011
(86) PCT No.: PCT/US11/45444

§ 371 Date: Jan. 29, 2013

Related U.S. Application Data
(60) Provisional application No. 61/368,792, filed on Jul. 29, 2010.

(51) Int. Cl. C09K 8/80; E21B 43/267

(52) U.S. Cl. CPC C09K 8/80; E21B 43/267
USPC 166/280.2; 525/327.3; 507/224

(57) ABSTRACT

A plurality of particles comprising a crosslinked aromatic epoxy vinyl ester polymer, wherein a particle from the plurality of proppant particles swells not more than 20 percent by volume when submerged in toluene for 24 hours at 70° C. is disclosed. A plurality of particles comprising a crosslinked aromatic epoxy vinyl ester polymer, wherein a particle from the plurality of particles maintains at least 75 percent of its height under a pressure of 1.7×10⁷ Pascals up to at least 135° C. is also disclosed. Mixtures of the plurality of particles and other particles, fluids containing the plurality of particles, methods of making the plurality of particles, and methods of fracturing a subterranean geological formation are also disclosed.

### CROSS-REFERENCE TO RELATED APPLICATIONS

This application claims priority to U.S. Provisional Application No. 61/368,792 filed Jul. 29, 2010, the disclosure of which is incorporated by reference herein in its entirety.

### BACKGROUND

Oil and natural gas can be produced from wells having porous and permeable subterranean formations. The porosity of the formation permits the formation to store oil and gas, and the permeability of the formation permits the oil or gas fluid to move through the formation. Permeability of the formation is essential to permit oil and gas to flow to a location where it can be pumped from the well. Sometimes the permeability of the formation holding the gas or oil is insufficient for the desired recovery of oil and gas. In other cases, during operation of the well, the permeability of the formation drops to the extent that further recovery becomes uneconomical. In such cases, it is common to fracture the formation and prop the fracture in an open condition using a proppant material or propping agent. The proppant material or propping agent is typically a particulate material, such as sand and (man-made) engineered proppants, such as resin coated sand and high-strength ceramic materials (e.g., sintered bauxite, crystalline ceramic bubbles, and ceramic (e.g., glass) beads), which are carried into the fracture by a fluid.

The extreme environments of temperature and pressure in a fracture and exposure to various chemicals in fracturing fluids provide many challenges for proppant materials. While certain crosslinked polymers have been used as proppants, there continues to be interest in finding polymeric materials that can withstand the challenging environment in a fractured formation.

### SUMMARY

Particles that typically demonstrate properties that exceed those of commercially available polymer proppant particles are disclosed herein. For example, the particles disclosed herein typically have greater resistance to swelling in solvents than commercially available polymer proppant particles. Furthermore, the particles disclosed herein typically have better resistance to deformation at higher temperatures and/or pressure than commercially available polymer proppant particles. These properties may render the plurality of particles according to the present disclosure more versatile than commercially available materials. For example, when used as proppants the plurality of particles according to the present disclosure may be useful at greater depths in subterranean formations than currently available polymer proppants.

In one aspect, the present disclosure provides a plurality of particles comprising a crosslinked aromatic epoxy vinyl ester polymer essentially free of inorganic fillers, wherein a particle from the plurality of particles swells not more than 20 percent by volume when submerged in toluene for 24 hours at 70° C.

In another aspect, the present disclosure provides a plurality of particles comprising a crosslinked aromatic epoxy vinyl ester polymer, wherein a particle from the plurality of particles maintains at least 75 percent of its height under a pressure of 1.7×10⁷ Pascals up to at least 135° C.

In another aspect, the present disclosure provides a method of making a plurality of particles according to either of the foregoing aspects, the method comprising:

providing a mixture comprising an aromatic epoxy vinyl ester resin having at least two vinyl ester functional groups, a catalyst, and optionally an accelerator for the catalyst;

suspending the mixture in a solution comprising water to form a suspension; and

initiating crosslinking of the aromatic epoxy vinyl ester resin to make the plurality of particles.

In another aspect, the present disclosure provides a plurality of mixed particles comprising the plurality of particles according to and/or prepared according to any of the foregoing aspects and other, different particles.

In another aspect, the present disclosure provides a fluid comprising a plurality of particles according to and/or prepared according to any of the foregoing aspects dispersed therein.

In another aspect, the present disclosure provides a method of fracturing a subterranean geological formation penetrated by a wellbore, the method comprising:

injecting into the wellbore penetrating the subterranean geological formation a fracturing fluid at a rate and pressure sufficient to form a fracture therein; and

introducing into the fracture a plurality of particles described above, a plurality of mixed particles described above, or a fluid described above.

In another aspect, the present disclosure provides a method of making a plurality of particles, the method comprising:

providing a mixture comprising an aromatic epoxy vinyl ester resin having at least two vinyl ester functional groups, a catalyst, and optionally an accelerator for the catalyst;

suspending the mixture in a solution comprising water to form a suspension, wherein the solution comprising water is essentially free of a suspending agent; and

initiating crosslinking of the aromatic epoxy vinyl ester resin to make the plurality of particles.

In this application, terms such as “a”, “an” and “the” are not intended to refer to only a singular entity, but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. All numerical ranges are inclusive of their endpoints and non-integral values between the endpoints unless otherwise stated.

The terms “first” and “second” are used in this disclosure. It will be understood that, unless otherwise noted, those terms are used in their relative sense only. For these components, the designation of “first” and “second” may be applied to the components merely as a matter of convenience in the description of one or more of the embodiments.

The term “plurality” refers to more than one. In some embodiments, the plurality of particles disclosed herein comprises at least 2, 10, 100, or 1000 of such particles.

The above summary of the present disclosure is not intended to describe each disclosed embodiment or every implementation of the present disclosure. The description that follows more particularly exemplifies illustrative embodiments. It is to be understood, therefore, that the following description should not be read in a manner that would unduly limit the scope of this disclosure.

### DETAILED DESCRIPTION

Crosslinked aromatic epoxy vinyl ester polymers as described herein will be understood to be preparable by crosslinking aromatic epoxy vinyl ester resins. The crosslinked aromatic epoxy vinyl ester polymer typically contains a repeating unit with at least one (in some embodiments, at least 2, in some embodiments, in a range from 1 to 4) aromatic ring (e.g., phenyl group) that is optionally substituted by a halogen (e.g., fluoro, chloro, bromo, iodo), alkyl having 1 to 4 carbon atoms (e.g., methyl or ethyl), or hydroxyalkyl having 1 to 4 carbon atoms (e.g., hydroxymethyl). For repeating units containing two or more aromatic rings, the rings may be connected, for example, by a branched or straight-chain alkylene group having 1 to 4 carbon atoms that may optionally be substituted by halogen (e.g., fluoro, chloro, bromo, iodo). The crosslinked aromatic epoxy vinyl ester resin will typically have divalent units represented by formula

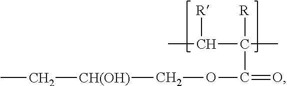

wherein R is hydrogen, methyl, or ethyl, wherein the methyl or ethyl group may optionally be halogenated, wherein R′ is hydrogen or phenyl, and wherein the terminal CH₂ group is linked directly or indirectly to the aromatic group described above (e.g., through a phenolic ether functional group).

In some embodiments, the crosslinked aromatic epoxy vinyl ester polymer is a novolac epoxy vinyl ester polymer. In these embodiments, the novolac epoxy vinyl ester polymer may be a phenol novolac, an ortho-, meta-, or para-cresol novolac, or a combination thereof. In some embodiments, the crosslinked aromatic epoxy vinyl ester polymer is a bisphenol diglycidyl acrylic or methacrylic polymer, wherein the bisphenol

(i.e., —O—C₆H₅—CH₂—C₆H₅—O—) may be unsubstituted (e.g., bisphenol F), or either of the phenyl rings or the methylene group may be substituted by halogen (e.g., fluoro, chloro, bromo, iodo), methyl, trifluoromethyl, or hydroxymethyl.

Epoxy vinyl ester resins useful for preparing crosslinked epoxy vinyl ester polymers are typically prepared, for example, by reacting a vinyl monocarboxylic acid (e.g., acrylic acid, methacrylic acid, ethacrylic acid, halogenated acrylic or methacrylic acids, cinnamic acid, and combinations thereof) and an aromatic polyepoxide (e.g., a chain-extended diepoxide or novolac epoxy resin having at least two epoxide groups) or a monomeric diepoxide. A crosslinkable epoxy vinyl ester resin therefore typically will have at least two end groups represented by formula

—CH₂—CH(OH)—CH₂—O—C(O)—C(R)═CH(R′), wherein R and R′ are as defined above. The aromatic polyepoxide or aromatic monomeric diepoxide typically contains at least one (in some embodiments, at least 2, in some embodiments, in a range from 1 to 4) aromatic ring that is optionally substituted by a halogen (e.g., fluoro, chloro, bromo, iodo), alkyl having 1 to 4 carbon atoms (e.g., methyl or ethyl), or hydroxyalkyl having 1 to 4 carbon atoms (e.g., hydroxymethyl). For epoxy resins containing two or more aromatic rings, the rings may be connected, for example, by a branched or straight-chain alkylene group having 1 to 4 carbon atoms that may optionally be substituted by halogen (e.g., fluoro, chloro, bromo, iodo).

Exemplary aromatic epoxy resins useful for reaction with vinyl monocarboxylic acids include novolac epoxy resins (e.g., phenol novolacs, ortho-, meta-, or para-cresol novolacs or combinations thereof), bisphenol epoxy resins (e.g., bisphenol A, bisphenol F, halogenated bisphenol epoxies, and combinations thereof), resorcinol epoxy resins, and tetrakis phenylolethane epoxy resins. Exemplary aromatic monomeric diepoxides useful for reaction with vinyl monocarboxylic acids include the diglycidyl ethers of bisphenol A and bisphenol F and mixtures thereof. However, in some embodiments, the aromatic epoxy vinyl ester resin is not solely derived from the monomeric diglycidyl ether of bisphenol A (i.e., the resin is other than bisphenol-A diglycidyl methacrylate). Instead, in some embodiments, bisphenol epoxy resins, for example, may be chain extended to have any desirable epoxy equivalent weight. In some embodiments, the aromatic epoxy resin (e.g., either a bisphenol epoxy resin or a novolac epoxy resin) may have an epoxy equivalent weight of at least 140, 150, 200, 250, 300, 350, 400, 450, or 500 grams per mole. In some embodiments, the aromatic epoxy resin may have an epoxy equivalent weight of up to 2500, 3000, 3500, 4000, 4500, 5000, 5500, or 6000 grams per mole. In some embodiments, the aromatic epoxy resin may have an epoxy equivalent weight in a range from 150 to 6000, 200 to 6000, 200 to 5000, 200 to 4000, 250 to 5000, 250 to 4000, 300 to 6000, 300 to 5000, or 300 to 3000 grams per mole.

In some embodiments, the crosslinked epoxy vinyl ester polymer is a copolymer of an aromatic epoxy vinyl ester resin as described in any of the above embodiments and at least one monofunctional monomer. Exemplary monofunctional monomers useful for preparing such copolymers include vinyl aromatics, acrylates, methacrylates, and vinyl ethers. For example, the monofunctional monomer may comprise at least one of styrene, vinyl toluene, α-methyl styrene, p-chlorostyrene, tert-butyl styrene, methyl methacrylate, ethyl methacrylate, isopropyl methacrylate, isobutyl methacrylate, tert-butyl methacrylate, tert-butyl acrylate, cyclohexyl methacrylate, phenoxyethyl acrylate, phenoxyethyl methacrylate, isobornyl methacrylate, isobornyl acrylate, phenyl methacrylate, benzyl methacrylate, nonylphenol methacrylate, cetyl acrylate, dicyclopentenyl (meth)acrylate, isobornylcyclohexyl acrylate, tetrahydrofurfuryl methacrylate, trifluoroethyl methacrylate, 1-adamantyl methacrylate, dicyclopentenyloxylethyl (meth)acrylate, dicyclopentanyl (meth)acrylate, and 3,3,5-trimethylcyclohexyl (meth)acrylate. In some embodiments, the crosslinked aromatic epoxy vinyl ester polymer is a copolymer of an aromatic epoxy vinyl ester resin and styrene.

A plurality of particles comprising a crosslinked aromatic epoxy vinyl ester polymer according to the present disclosure can be made, for example, by suspension polymerization. Typically, a mixture of at least one aromatic epoxy vinyl ester resin having at least two vinyl ester functional groups, a catalyst (e.g., a free-radical initiator), optionally at least one monofunctional monomer, and optionally an accelerator for the catalyst is suspended in a solution comprising water (i.e., an aqueous solution) to form a suspension. The mixture can be made by stirring the mixture components together before combining the mixture and the aqueous solution. Typically, the suspension is made by stirring the mixture in the aqueous solution to form beads of the mixture suspended in the aqueous solution. An accelerator for the catalyst can also be added to the suspension, for example, if it is not present in the mixture. Initiating crosslinking of the epoxy vinyl ester resin can be carried out, for example, by heating. Heating the suspension at least to the temperature that the catalyst initiates typically will cause the vinyl ester functional groups and any other vinyl groups present to react and crosslink to form the plurality of particles. In some embodiments, for example, when an accelerator is present either in the mixture or in the suspension, heating may not be necessary. Initiating crosslinking of the epoxy vinyl ester resin in these embodiments may be carried out, for example, by adding the accelerator to the suspension and stirring at room temperature without using external heating.

The aromatic epoxy vinyl ester resin that can be polymerized using this method can be any of those described above. For example, in some embodiments, the aromatic epoxy vinyl ester resin is a novolac epoxy vinyl ester resin. In these embodiments, the novolac epoxy vinyl ester resin may be a phenol novolac, an ortho-, meta-, or para-cresol novolac, or a combination thereof. In some embodiments, the aromatic epoxy vinyl ester resin is a bisphenol diglycidyl acrylic or methacrylic resin, wherein the bisphenol

(i.e., —O—C₆H₅—CH₂—C₆H₅—O—) may be unsubstituted (e.g., bisphenol F), or either of the phenyl rings or the methylene group may be substituted by halogen (e.g., fluoro, chloro, bromo, iodo), methyl, trifluoromethyl, or hydroxymethyl.

The optional monofunctional monomer that can be included in the mixture and copolymerized with the aromatic epoxy vinyl ester resin can be any of those described above. The monofunctional monomer may be present in the mixture comprising the aromatic epoxy vinyl ester resin in an amount ranging from 0 to 35 (in some embodiments, 5 to 35, 10 to 35, 15 to 35, 0 to 30, 5 to 30, 10 to 30, or 15 to 30) percent by weight, based on the total weight of the monofunctional monomer and the aromatic epoxy vinyl ester resin. In some embodiments, the mixture comprising the aromatic epoxy vinyl ester resin further comprises styrene. In some of these embodiments, styrene may be present in the mixture comprising the aromatic epoxy vinyl ester resin in an amount ranging from 0 to 35 (in some embodiments, 5 to 35, 10 to 35, 15 to 35, 0 to 30, 5 to 30, 10 to 30, or 15 to 30) percent by weight, based on the total weight of styrene and the aromatic epoxy vinyl ester resin.

Several aromatic epoxy vinyl ester resins useful for preparing the plurality of particles according to and/or prepared according to the present disclosure are commercially available. For example, epoxy diacrylates such as bisphenol A epoxy diacrylates and epoxy diacrylates diluted with other acrylates are commercially available, for example, from Cytec Industries, Inc., Smyrna, Ga., under the trade designation “EBECRYL”. Aromatic epoxy vinyl ester resins such as novolac epoxy vinyl ester resins diluted with styrene are available, for example, from Ashland, Inc., Covington, Ky., under the trade designation “DERAKANE” (e.g., “DERAKANE 470-300”) and from Interplastic Corporation, St. Paul, Minn., under the trade designation “CoREZYN” (e.g., “CoREZYN 8730” and “CoREZYN 8770”).

Exemplary useful catalysts include azo compounds (e.g., 2,2′-azobisisobutyronitrile (AIBN), 2,2′-azobis(2-methylbutyronitrile), or azo-2-cyanovaleric acid), hydroperoxides (e.g., cumene, tert-butyl or tert-amyl hydroperoxide), dialkyl peroxides (e.g., di-tert-butyl or dicumylperoxide), peroxyesters (e.g., tert-butyl perbenzoate or di-tert-butyl peroxyphthalate), diacylperoxides (e.g., benzoyl peroxide or lauryl peroxide), methyl ethyl ketone peroxide, and potassium persulfate. Any suitable amount of catalyst may be used, depending on the desired reaction rate. In some embodiments, the amount of catalyst is in a range from 0.1 to 5 (in some embodiments, 0.5 to 3, or 0.5 to 2.5) percent by weight, based on the total weight of the mixture. Suitable exemplary accelerators (e.g., for peroxide catalysts) include tertiary amines such as N,N-dimethyl-p-toluidine and N,N-dimethylaniline. Any suitable amount of accelerator may be used, depending on the catalyst and reaction temperature. In some embodiments, the amount of accelerator is in a range from 0.01 to 2 (in some embodiments, 0.05 to 1, or 0.05 to 0.5) percent by weight, based on the total weight of the mixture.

The temperature to which the suspension is heated can be selected by those skilled in the art based on considerations such as the temperature required for the use of a particular initiator. While it is not practical to enumerate a particular temperature suitable for all initiators, generally suitable temperatures are in a range from about 30° C. to about 200° C. (in some embodiments, from about 40° C. to about 100° C., or from about 40° C. to about 90° C.). Heating can be carried out using a variety of techniques. For example, the suspension can be stirred in a flask that is placed on a hot plate or water bath.

In some embodiments of the method according to the present disclosure, the aqueous solution comprises a suspending agent, which may be either an organic or inorganic suspending agent. Exemplary useful suspending agents include cellulose polymers (e.g., methyl cellulose, carboxy methyl cellulose, carboxymethyl methyl cellulose, hydroxypropyl methyl cellulose, and hydroxybutyl methyl cellulose); gelatin; polyvinylalcohol; partially hydrolyzed polyvinyl alcohol; acrylate polymers and methacrylate polymers (e.g., polymethacrylic acid, sodium poly(methacrylic acid) and ammonium poly(methacrylic acid)); poly(styrene sulfonates) (e.g., sodium poly(styrene sulfonate)); talc; hydroxyapatite; barium sulfate; kaolin; magnesium carbonate; magnesium hydroxide; calcium phosphate; and aluminum hydroxide. While it has been suggested that suspending agents are required to prepare beads of vinyl ester resins (see, e.g., U.S. Pat. No. 4,398,003 (Irwin)), it has now been unexpectedly found that the method according to the present disclosure can be carried out in the absence of a suspending agent. Accordingly, in some embodiments of the method of making a plurality of particles according to the present disclosure, the solution comprising water is essentially free of a suspending agent. The solution comprising water may be essentially free of an organic suspending agent, for example. More specifically, the solution comprising water may be essentially free of a cellulose polymer. Solutions that are “essentially free of a suspending agent” include those that are free of (i.e., have no added) suspending agents. Solutions that are “essentially free of a suspending agent” can also include solutions that have less than about 0.1, 0.075, 0.05, 0.025, or 0.01 percent by weight of a suspending agent based on the weight of the solution comprising water before it is combined with the mixture comprising the aromatic epoxy vinyl ester resin.

In some embodiments of the method of making a plurality of particles according to the present disclosure, the method further comprises separating the plurality of particles from the solution comprising water and subjecting the plurality of particles to post-polymerization heating at a temperature of at least 130° C. Separating the plurality of particles can be carried out using conventional techniques (e.g., filtering or decanting). Optionally the suspension can be filtered through at least one sieve to collect a desired graded fraction of the plurality of particles. Post-polymerization heating can advance crosslinking and network formation as described further below. In some embodiments, the particles disclosed herein are subjected to post-polymerization heating at a temperature of at least 135° C. (in some embodiments, at least 140° C., 145° C., 150° C., or 155° C.). Post-polymerization heating can be carried out at any temperature in a range, for example, from 130° C. to 220° C. Post-polymerization heating can conveniently be carried out in an oven, typically for at least 30 minutes, although shorter and longer periods of time may be useful. Post-polymerization heating can be carried out at a single temperature or more than one temperature. For example, the plurality of particles may be heated at 130° C. for a first period of time (e.g., in a range from 15 to 60 minutes) and then at a higher temperature (e.g., in a range from 150° C. to 220° C.) for a second period of time (e.g., in a range from 15 to 60 minutes).

Particles according to the present disclosure typically demonstrate high resistance to deformation. In some embodiments, particles according to the present disclosure can be exposed to pressure (e.g., up to 1.7×10⁷ Pa, 3.4×10⁷ Pa, 5.1×10⁷ Pa, or 6.9×10⁷ Pa) and temperature (e.g., up to 80° C., 90° C., 100° C., 110° C., 120° C., 130° C., or higher) while maintaining at least 50 (in some embodiments, 60, 75, or 90 percent) of its height without permanent deformation (i.e., creep) or brittle failure. In many embodiments of the plurality of particles disclosed herein, a particle from the plurality of particles maintains at least 75 percent of its height under a pressure of 1.7×10⁷ Pascals up to a temperature of at least 135° C. (in some embodiments, at least 136° C., 138° C., 140° C., or 145° C.). The term height may be understood to be the same as diameter when evaluating substantially spherical particles. In some embodiments of the plurality of particles disclosed herein, any particle within the plurality of particles maintains at least 75 percent of its height under the conditions described above. In some embodiments of the plurality of particles, substantially all of the particles in the plurality of particles may maintain at least 75 percent of their heights under these conditions. Substantially all can mean, for example, at least 90, 95, or 99 percent of the particles in the plurality of particles.

A particle can be evaluated to determine whether it maintains at least 75 percent of its height under a pressure of 1.7×10⁷ Pascals up to a temperature of at least 135° C., for example, using a Dynamic Mechanical Analyzer in compression mode. The details of the evaluation are provided in the Examples, below. The pressure is determined by the static force used in the evaluation divided by the cross-sectional area of the particle being evaluated. The results of the evaluation may vary somewhat (e.g., up to a 20% difference in temperature) depending on the size of the particle being evaluated. Therefore, for evaluating the temperature up to which a particle maintains its height under static compression, it is useful to choose a particle from a plurality of particles that has an initial height in a range from 0.5 to 1.5 millimeters. When more than one particle is evaluated, the average temperature obtained from the evaluation will be at least 135° C. (in some embodiments, at least 136° C., 138° C., 140° C., or 145° C.).

A particle from the plurality of particles according to the present disclosure typically maintains at least 50 percent of its height under a pressure of 1.7×10⁷ Pascals up to a higher temperature than the temperature up to which it maintains 75 percent of its height. In some embodiments, a particle from the plurality of particles according to the present disclosure typically maintains at least 50 percent of its height under a pressure of 1.7×10⁷ Pascals up to a second temperature that is at least twenty (in some embodiments, 25, 30, 35, 40, 45, or 50) percent higher than a first temperature, wherein the first temperature is the temperature up to which the particle maintains 75 percent of its height. The percentage can be determined by dividing the difference between the two temperatures in degrees Celsius by the lower temperature value and multiplying by 100. In many embodiments of the plurality of particles disclosed herein, a particle from the plurality of particles maintains at least 50 percent of its height under a pressure of 1.7×10⁷ Pascals up to a temperature of at least 190° C. (in some embodiments, at least 195° C., 200° C., 205° C., or 210° C.).

Particles according to the present disclosure typically demonstrate high resistance to swelling in various solvents. For particles being used as proppants, resistance to swelling in various fluids (e.g., oil, xylene, toluene, methanol, carbon dioxide, and hydrochloric acid) is also a desirable product characteristic as excessive swelling and any degradation after exposure to such fluids can negatively impact the ability of the proppants to be injected into a fracture and the ability of the proppants to withstand the temperatures and pressures within the fracture. The plurality of particles according to the present disclosure typically has high resistance to swelling in oil or condensate, aromatics (e.g., xylene and toluene), methanol, carbon dioxide, and hydrochloric acid. In many embodiments of the plurality of particles disclosed herein, a particle from the plurality of particles swells not more than 20 (in some embodiments, not more than 18, 16, 15, or 10) percent by volume when submerged in toluene for 24 hours at 70° C. In some embodiments of the plurality of particles disclosed herein, any particle within the plurality of particles swells not more than 20 (in some embodiments, not more than 18, 16, 15, or 10) percent by volume when submerged in toluene for 24 hours at 70° C. In some embodiments of the plurality of particles, substantially all of the particles in the plurality of particles may exhibit the indicated resistance to swelling in toluene. Substantially all can mean, for example, at least 90, 95, or 99 percent of the particles in the plurality of particles. For the purposes of the present disclosure, the percent volume swelling is determined by measuring the diameter of a sample of particles using a microscope. Details of the evaluation are provided in the Examples, below.

Epoxy vinyl ester resins have been generally described as resins that may be useful for forming thermoset beads for use as proppants. See, for example, U.S. Pat. Appl. Pub. Nos. 2007/0021309 (Bicerano), 2007/0181302 (Bicerano), 2007/0066491 (Bicerano et al.), 2007/0161515 (Bicerano), and 2007/0144736 (Shinbach et al.). However, the art does not describe a plurality of particles made from epoxy vinyl ester resins that have a deformation resistance wherein a particle from the plurality of the particles maintains at least 75 percent of its height when placed under a pressure of 1.7×10⁷ Pascals up to a temperature of at least 135° C. (in some embodiments, at least 136° C., 138° C., 140° C., or 145° C.). As shown in the Examples, below, not all particles exhibit this level of deformation resistance. For example, currently commercially available polymer proppant particles do not exhibit this deformation resistance. Furthermore, not all crosslinked epoxy vinyl ester polymer particles exhibit this deformation resistance. The level of deformation resistance achieved by the plurality of particles according to the present disclosure is therefore surprisingly high when considering commercially available polymer proppant particles and other particles in the class of epoxy vinyl ester particles.

Also, the art listed above does not describe a plurality of particles made from epoxy vinyl ester resins, wherein a particle from the plurality of particles swells not more than 20 (in some embodiments, not more than 18, 16, 15, or 10) percent by volume when submerged in toluene for 24 hours at 70° C. As shown in the Examples, below, not all particles exhibit this level of resistance to swelling. For example, currently commercially available polymer proppant particles do not exhibit this resistance to swelling in toluene. Furthermore, not all crosslinked epoxy vinyl ester polymer particles exhibit this feature. The level of resistance to swelling in toluene achieved by the plurality of particles according to the present disclosure is therefore surprisingly high when considering commercially available polymer proppant particles and other particles in the class of epoxy vinyl ester particles.

We have found that the amount of monofunctional monomer contained in the initial aromatic epoxy vinyl ester resin influences the deformation resistance and solvent resistance of the resultant crosslinked particles. As shown in the Illustrative Examples, below, as the styrene content in the starting resin is increased, the temperature up to which a particle from the plurality of particles maintains 75 percent of its height under a pressure of 1.7×10⁷ Pascals (2500 psi) decreases, indicating a decreased resistance to deformation. Similarly, as the styrene content in the starting resin increases, the percent volume increase of a particle after being submerged in toluene for 24 hours at 70° C. also increases. The amount of styrene that can be tolerated in the initial aromatic epoxy vinyl ester resin while maintaining a high deformation resistance and high solvent resistance varies with the selection of aromatic epoxy vinyl ester resin. For example, novolac epoxy vinyl ester resins combined with a certain amount of styrene may provide crosslinked particles with better deformation resistance and solvent resistance than bisphenol A epoxy vinyl ester resins combined with the same amount of styrene. In some embodiments, the styrene is present in combination with the epoxy vinyl ester resin in an amount up to 35 (in some embodiments, up to 34, 33, or 32) percent by weight, based on the total weight of the styrene and the aromatic epoxy vinyl ester resin. Similarly, in some embodiments of the proppant particle, copolymerized styrene is present in an amount up to 35 (in some embodiments, up to 34, 33, or 32) percent by weight, based on the total weight of the copolymer in the plurality of particles.

The amount of monofunctional monomer contained in the initial aromatic epoxy vinyl ester resin is believed to relate to the amount of crosslinking (i.e., crosslink density) in the resultant particles. Relative comparisons of crosslink density in a thermoset polymer can be made by solvent swelling, for example, using the evaluation of a particle from the plurality of particles for swelling in toluene disclosed herein.

Another factor that can influence the deformation resistance and solvent resistance of the plurality of particles disclosed herein is a post-polymerization heating step. Post-polymerization heating can advance crosslinking and network formation. Therefore, it may increase crosslink density. As shown in the Examples, below, the absence of a post-polymerization heating step can result in a low temperature (e.g., less than 100° C.) up to which a particle from the plurality of particles maintains at least 75 percent of its height under a pressure of 1.7×10⁷ Pascals. When post-polymerization heating was carried out, increasing the heating temperature tended to increase the temperature up to which a particle from the plurality of particles maintains at least 75 percent of its height under a pressure of 1.7×10⁷ Pascals. In some embodiments, the particles disclosed herein are subjected to post-polymerization heating at a temperature of at least 130° C. (in some embodiments, at least 140° C., 145° C., 150° C., or 155° C.).

Another factor that can influence the deformation resistance and solvent resistance of the plurality of particles disclosed herein is the presence of impact modifiers or plasticizers in the initial aromatic epoxy vinyl ester resin formulation. As shown in the Examples, below, the presence of an impact modifier or plasticizer can result in a temperature up to which a particle from the plurality of particles maintains at least 75 percent of its height under a pressure of 1.7×10⁷ Pascals of less than 130° C. Also, the presence of an impact modifier or plasticizer can increase the level of swelling in toluene as shown in Illustrative Example 1 and Comparative Example 3.

In some embodiments, the plurality of particles disclosed herein comprises at least one filler. In some embodiments, the filler comprises at least one of glass microbubbles, glass microspheres, silica (e.g., including nanosilica), calcium carbonate (e.g., calcite or nanocalcite), ceramic microspheres, aluminum silicate (e.g., kaolin, bentonite clay, wollastonite), carbon black, mica, micaceous iron oxide, aluminum oxide, or feldspar. Glass microbubbles are known in the art and can be obtained commercially and/or be made by techniques known in the art (see, e.g., U.S. Pat. Nos. 2,978,340 (Veatch et al.); 3,030,215 (Veatch et al.); 3,129,086 (Veatch et al.); and 3,230,064 (Veatch et al.); 3,365,315 (Beck et al.); 4,391,646 (Howell); and 4,767,726 (Marshall); and U.S. Pat. App. Pub. No. 2006/0122049 (Marshall et. al). Useful glass microbubbles include those marketed by Potters Industries, Valley Forge, Pa., (an affiliate of PQ Corporation) under the trade designation “SPHERICEL HOLLOW GLASS SPHERES” (e.g., grades 110P8 and 60P18) and glass bubbles marketed by 3M Company, St. Paul, Minn., under the trade designation “3M GLASS BUBBLES” (e.g., grades S60, S60HS, and iM30K). Glass microspheres are available, for example, from Diversified Industries, Sidney, British Columbia, Canada; and 3M Company. Useful ceramic microspheres include those marketed by 3M Company under the trade designation “3M CERAMIC MICROSPHERES” (e.g., grades W-610).

When fillers are incorporated into the plurality of particles disclosed herein, typically the crosslinked aromatic epoxy vinyl ester polymer remains the continuous phase. That is, the filler is typically incorporated into and surrounded by the crosslinked polymer matrix. In some embodiments, the crosslinked aromatic epoxy vinyl ester polymers disclosed herein have up to 40, 35, 30, 25, or 20 percent by weight filler, based on the total weight of the particles. It is generally thought in the art that fillers may be useful for improving the properties of some thermoset polymer beads, for example, the stiffness and strength of the beads. Typically, and surprisingly, we have found that the crosslinked aromatic epoxy vinyl ester polymers disclosed herein have excellent static compression resistance even in the absence of fillers. In fact, in some embodiments, the crosslinked aromatic epoxy vinyl ester polymer beads may have better properties in the absence of a filler than in the presence of a filler. For example, typically a particle from the plurality of particles maintains at least 50 percent of its height under a pressure of 1.7×10⁷ Pascals up to a higher temperature in the absence of filler than in the presence of filler. Typically there is less than a twenty percent difference between the temperature up to which a particle maintains 50 percent of its height and the temperature up to which a particle maintains 75 percent of its height when filler is present in the particles. Accordingly, in some embodiments, the crosslinked aromatic epoxy vinyl ester polymer is essentially free of fillers (in some embodiments, essentially free of inorganic filler). “Essentially free of fillers” (e.g., inorganic filler) can mean that the particles have no added fillers, e.g., fillers such as glass microbubbles, glass microspheres, silica (e.g., including nanosilica), calcium carbonate (e.g., calcite, nanocalcite), ceramic microspheres, aluminum silicate (e.g., kaolin, bentonite clay, or wollastonite), carbon black, mica, micaceous iron oxide, aluminum oxide, and feldspar. “Essentially free of fillers” (e.g., inorganic filler) can also mean that the particles have filler at a level insufficient to significantly change the physical properties of the particles. For example, the crosslinked aromatic epoxy vinyl ester polymer may comprise up to one (in some embodiments, 0.75, 0.5, 0.25, or 0.1) percent by weight of filler, based on the total weight of the particles.

The incorporation of fillers, among other techniques, may be useful for altering the density of a particle from the plurality of particles disclosed herein. In some embodiments, the density of the particles disclosed herein is in a range from 0.6 to 1.5 (in some embodiments, 0.7 to 1.5, 0.95 to 1.3, or 1 to 1.2) grams per cubic centimeter. The density of the particles in the plurality of particles may be adjusted to match the density of a fluid into which they are dispersed, for example, in a fracturing and propping operation. This allows the proppant particles to travel further into a fracture with minimal input of energy, which can result in a several-fold increase in effective fracture conductivity and accompanying enhanced oil recovery.

While the plurality of particles disclosed herein can include fillers, it should be understood that the particles comprising the crosslinked aromatic epoxy vinyl ester polymer are not typically particles having a ceramic core coated with the crosslinked aromatic epoxy vinyl ester polymer. In other words, the particles disclosed herein typically do not belong to the category of resin-coated proppants or resin-coated sand. Instead, the particles disclosed herein may be understood to belong to the class of polymer beads or proppants. The crosslinked aromatic epoxy vinyl ester polymer forms part of the core and the exterior of the particles. It may be understood that the polymer and optionally any fillers may be distributed throughout the particles.

Advantages of the plurality of particles disclosed herein include that they are relatively low in density yet provide relatively high deformation resistances up to high temperatures and high resistance to swelling. Because of their relatively low density, they can be used with lower viscosity, cheaper carrier fluids (described below). Their high deformation resistance and high temperature performance renders them useful, for example, in fractures at depths of at least 500, 1000, 1500, 2000, 2500, 3000, 3500, 4000, 4500, or 5000 meters. The plurality of particles disclosed herein may be useful as fracture proppants at depths, for example, up to 8000, 7500, 7000, 6500, or 6000 meters. These depths may correspond, for example, to closure pressures in a range from 500 psi to 15,000 psi (3.4×10⁷ Pa to 1.0×10⁸ Pa).

The particles disclosed herein may, in some embodiments, comprise an impact modifier (e.g., an elastomeric resin or elastomeric filler). Exemplary impact modifiers include polybutadiene, butadiene copolymers, polybutene, ground rubber, block copolymers, ethylene terpolymers, particles available, for example, from Akzo Nobel, Amsterdam, The Netherlands, under the trade designation “EXPANCEL”, EPDM rubber, and core-shell polymer particles. It is generally thought in the art that impact polymers may be useful for improving the properties of some thermoset polymer beads, for example, so that they do not undergo brittle failure in a fracture. Typically, and surprisingly, we have found that the crosslinked aromatic epoxy vinyl ester polymers disclosed herein have excellent deformation resistance even in the absence of impact modifiers. In fact, in some embodiments, the crosslinked aromatic epoxy vinyl ester polymer particles may have better properties in the absence of an impact modifier than in the presence of an impact modifier. Accordingly, in some embodiments, the crosslinked aromatic epoxy vinyl ester polymer is essentially free of an impact modifier. “Essentially free of an impact modifier” can mean that the particles have no added impact modifier, e.g., an elastomeric resin or elastomeric filler. “Essentially free of an impact modifier” can also mean that the particles have an impact modifier at a level insufficient to change the compression properties of the particles. For example, the crosslinked aromatic epoxy vinyl ester polymer may comprise up to one (in some embodiments, 0.75, 0.5, 0.25, or 0.1) percent by weight of an impact modifier, based on the total weight of the particles.

Typically, the plurality of particles according to the present disclosure comprises particles with a size in a range from 100 micrometers to 3000 micrometers (i.e., about 140 mesh to about 5 mesh (ANSI)) (in some embodiments, in a range from 1000 micrometers to 3000 micrometers, 1000 micrometers to 2000 micrometers, 1000 micrometers to 1700 micrometers (i.e., about 18 mesh to about 12 mesh), 850 micrometers to 1700 micrometers (i.e., about 20 mesh to about 12 mesh), 850 micrometers to 1200 micrometers (i.e., about 20 mesh to about 16 mesh), 600 micrometers to 1200 micrometers (i.e., about 30 mesh to about 16 mesh), 425 micrometers to 850 micrometers (i.e., about 40 mesh to about 20 mesh), or 300 micrometers to 600 micrometers (i.e., about 50 mesh to about 30 mesh). In some embodiments of the plurality of particles disclosed herein, any particle within the plurality of particles has a size that can be within one of these embodiment ranges. In some embodiments of the plurality of particles, substantially all of the particles in the plurality of particles can be within one of these embodiment size ranges. Substantially all can mean, for example, not more than 0.1 weight % of the particulates are larger than the larger size and not more than 2 or 1 weight % are smaller than the smaller size. The size of the plurality of particles is typically controlled by the stirring rate during suspension polymerization described above. High shear forces in the suspension result in smaller particle sizes. Desired graded fractions of the plurality of particles may be obtained using conventional classification techniques (e.g., sieving). The size of the particles desired may depend, for example, on the characteristics of a subterranean formation selected for a fracturing and propping operation.

The shape of the particles in the plurality of particles disclosed herein is typically at least somewhat spherical although the sphericity of the particles is not critical to this disclosure. The plurality of particles disclosed herein will typically meet or exceed the standards for sphericity and roundness as measured according to American Petroleum Institute Method RP56, “Recommended Practices for Testing Sand Used in Hydraulic Fracturing Operations”, Section 5, (Second Ed., 1995) (referred to herein as “API RP 56”). As used herein, the terms “sphericity” and “roundness” are defined as described in the API RP's and can be determined using the procedures set forth in the API RP's. In some embodiments, the sphericity of any particle in the plurality of particles is at least 0.6 (in some embodiments, at least 0.7, 0.8, or 0.9). In some embodiments, the roundness of any particle in the plurality of particles is at least 0.6 (in some embodiments, at least 0.7, 0.8, or 0.9).

The present disclosure provides plurality of mixed particles comprising the plurality of particles disclosed herein and other particles. The other particles may be conventional proppant materials such as at least one of sand, resin-coated sand, graded nut shells, resin-coated nut shells, sintered bauxite, particulate ceramic materials, glass beads, and particulate thermoplastic materials. Sand particles are available, for example, from Badger Mining Corp., Berlin, Wis.; Borden Chemical, Columbus, Ohio; Fairmont Minerals, Chardon, Ohio. Thermoplastic particles are available, for example, from the Dow Chemical Company, Midland, Mich.; and Baker Hughes, Houston, Tex. Clay-based particles are available, for example, from CarboCeramics, Irving, Tex.; and Saint-Gobain, Courbevoie, France. Sintered bauxite ceramic particles are available, for example, from Borovichi Refractories, Borovichi, Russia; 3M Company, St. Paul, Minn.; CarboCeramics; and Saint Gobain. Glass beads are available, for example, from Diversified Industries, Sidney, British Columbia, Canada; and 3M Company. Generally, the sizes of other particles may be in any of the size ranges described above for the plurality of proppant particles disclosed herein. Mixing other particles (e.g., sand) and the plurality of particles disclosed herein may be useful, for example, for reducing the cost of proppant particles while maintaining at least some of the beneficial properties of the plurality of particles disclosed herein.

In some embodiments, the plurality of particles disclosed herein is dispersed in a fluid. The fluid may be a carrier fluid useful, for example, for depositing proppant particles into a fracture. A variety of aqueous and non-aqueous carrier fluids can be used with the plurality of particles disclosed herein. In some embodiments, the fluid comprises at least one of water, a brine, an alcohol, carbon dioxide (e.g., gaseous, liquid, or supercritical carbon dioxide), nitrogen gas, or a hydrocarbon. In some embodiments, the fluid further comprises at least one of a surfactant, rheological modifier, salt, gelling agent, breaker, scale inhibitor, dispersed gas, or other particles.

Illustrative examples of suitable aqueous fluids and brines include fresh water, sea water, sodium chloride brines, calcium chloride brines, potassium chloride brines, sodium bromide brines, calcium bromide brines, potassium bromide brines, zinc bromide brines, ammonium chloride brines, tetramethyl ammonium chloride brines, sodium formate brines, potassium formate brines, cesium formate brines, and any combination thereof. Rheological modifiers may be added to aqueous fluid to modify the flow characteristics of the fluid, for example. Illustrative examples of suitable water-soluble polymers that can be added to aqueous fluids include guar and guar derivatives such as hydroxypropyl guar (HPG), carboxymethylhydroxypropyl guar (CMHPG), carboxymethyl guar (CMG), hydroxyethyl cellulose (HEC), carboxymethylhydroxyethyl cellulose (CMHEC), carboxymethyl cellulose (CMC), starch based polymers, xanthan based polymers, and biopolymers such as gum Arabic, carrageenan, as well as any combination thereof. Such polymers may crosslink under downhole conditions. As the polymer undergoes hydration and crosslinking, the viscosity of the fluid increases, which may render the fluid more capable of carrying the proppant. Another class of rheological modifier is viscoelastic surfactants (“VES's”).

Exemplary suitable non-aqueous fluids useful for practicing the present disclosure include alcohols (e.g., methanol, ethanol, isopropanol, and other branched and linear alkyl alcohols); diesel; raw crude oils; condensates of raw crude oils; refined hydrocarbons (e.g., gasoline, naphthalenes, xylenes, toluene and toluene derivatives, hexanes, pentanes, and ligroin); natural gas liquids; gases (e.g., carbon dioxide and nitrogen gas); liquid carbon dioxide; supercritical carbon dioxide; liquid propane; liquid butane; and combinations thereof. Some hydrocarbons suitable for use as such fluids can be obtained, for example, from SynOil, Calgary, Alberta, Canada under the trade designations “PLATINUM”, “TG-740”, “SF-770”, “SF-800”, “SF-830”, and “SF-840”. Mixtures of the above non-aqueous fluids with water (e.g., mixtures of water and alcohol or several alcohols or mixtures of carbon dioxide (e.g., liquid carbon dioxide) and water) may also be useful for practicing the present disclosure. Mixtures can be made of miscible or immiscible fluids. Rheological modifiers (e.g., a phosphoric acid ester) can be useful in non-aqueous fluids as well. In some of these embodiments, the fluid further comprises an activator (e.g., a source of polyvalent metal ions such as ferric sulfate, ferric chloride, aluminum chloride, sodium aluminate, and aluminum isopropoxide) for the gelling agent.

Fluid containing a plurality of particles according to the present disclosure dispersed therein can also include at least one breaker material (e.g., to reduce viscosity of the fluid once it is in the well). Examples of suitable breaker materials include enzymes, oxidative breakers (e.g., ammonium peroxydisulfate), encapsulated breakers such as encapsulated potassium persulfate (e.g., available, for example, under the trade designation “ULTRAPERM CRB” or “SUPERULTRAPERM CRB”, from Baker Hughes), and breakers described in U.S. Pat. No. 7,066,262 (Funkhouser).

Fluids having a plurality of particles according to the present disclosure dispersed therein may also be foamed. Foamed fluids may contain, for example, nitrogen, carbon dioxide, or mixtures thereof at volume fractions ranging from 10% to 90% of the total fluid volume.

The fluids described above, in any of their embodiments, may be useful, for example, for practicing the method of fracturing a subterranean geological formation penetrated by a wellbore according to the present disclosure. Techniques for fracturing subterranean geological formations comprising hydrocarbons are known in the art, as are techniques for introducing proppants into the fractured formation to prop open fracture openings. In some methods, a fracturing fluid is injected into the subterranean geological formation at rates and pressures sufficient to open a fracture therein. When injected at the high pressures exceeding the rock strength, the fracturing fluid opens a fracture in the rock. The fracturing fluid may be an aqueous or non-aqueous fluid having any of the additives described above. Particles described herein can be included in the fracturing fluid. That is, in some embodiments, injecting the fracturing fluid and introducing the plurality of particles are carried out simultaneously. In other embodiments, the plurality of particles disclosed herein may be present in a second fluid (described in any of the above embodiments) that is introduced into the well after the fracturing fluid is introduced. As used herein, the term “introducing” (and its variants “introduced”, etc.) includes pumping, injecting, pouring, releasing, displacing, spotting, circulating, or otherwise placing a fluid or material (e.g., proppant particles) within a well, wellbore, fracture or subterranean formation using any suitable manner known in the art. The plurality of particles according to the present disclosure can serve to hold the walls of the fracture apart after the pumping has stopped and the fracturing fluid has leaked off or flowed back. The plurality of particles according to the present disclosure may also be useful, for example, in fractures produced by etching (e.g., acid etching). Fracturing may be carried out at a depth, for example, in a range from 500 to 8000 meters, 1000 to 7500 meters, 2500 to 7000 meters, or 2500 to 6000 meters.

The carrier fluid carries particles into the fractures where the particles are deposited. If desired, particles might be color coded and injected in desired sequence such that during transmission of subject fluid therethrough, the extracted fluid can be monitored for presence of particles. The presence and quantity of different colored particles might be used as an indicator of what portion of the fractures are involved as well as indicate or presage possible changes in transmission properties.

### Selected Embodiments of the Disclosure

In a first embodiment, the present disclosure provides a plurality of particles comprising a crosslinked aromatic epoxy vinyl ester polymer essentially free of inorganic filler, wherein a particle from the plurality of particles swells not more than 20 percent by volume when submerged in toluene for 24 hours at 70° C.

In a second embodiment, the present disclosure provides a plurality of particles comprising a crosslinked aromatic epoxy vinyl ester polymer, wherein a particle from the plurality of particles maintains at least 75 percent of its height under a pressure of 1.7×10⁷ Pascals up to at least 135° C.

In a third embodiment, the present disclosure provides a plurality of particles according to the second embodiment, wherein the particle swells not more than 20 percent by volume when submerged in toluene for 24 hours at 70° C.

In a fourth embodiment, the present disclosure provides a plurality of particles according to any one of the first to third embodiments, wherein the particle maintains 50 percent of its height under a pressure of 1.7×10⁷ Pascals up to a second temperature that is at least twenty percent higher than a first temperature, wherein the first temperature is the temperature up to which the particle maintains 75 percent of its height.

In a fifth embodiment, the present disclosure provides a plurality of particles according to any one of the first to fourth embodiments, wherein the crosslinked aromatic epoxy vinyl ester polymer is a novolac epoxy vinyl ester polymer.

In a sixth embodiment, the present disclosure provides a plurality of particles according to any one of the first to fourth embodiments, wherein the crosslinked aromatic epoxy vinyl ester polymer is a bisphenol diglycidyl acrylic or methacrylic polymer.

In a seventh embodiment, the present disclosure provides a plurality of particles according to any one of the first to sixth embodiments, wherein the crosslinked aromatic epoxy vinyl ester polymer is a copolymer of an aromatic epoxy vinyl ester and at least one of a vinyl aromatic compound or a monofunctional acrylate or methacrylate.

In an eighth embodiment, the present disclosure provides a plurality of particles according to the seventh embodiment, wherein the crosslinked aromatic epoxy vinyl ester polymer is a copolymer of an aromatic epoxy vinyl ester and styrene, wherein the styrene is present in an amount up to 35 percent by weight, based on the total weight of the copolymer.

In a ninth embodiment, the present disclosure provides a plurality of particles according to any one of the first to eighth embodiments, further comprising at least one of glass microbubbles, glass microspheres, silica, calcium carbonate, ceramic microspheres, aluminum silicate, carbon black, mica, micaceous iron oxide, aluminum oxide, or feldspar dispersed within the crosslinked aromatic epoxy vinyl ester polymer.

In a tenth embodiment, the present disclosure provides a plurality of particles according to the ninth embodiment, wherein the plurality of particles comprise at least one of glass microbubbles, glass microspheres, or ceramic microspheres.

In an eleventh embodiment, the present disclosure provides a plurality of particles according to any one of the first to tenth embodiments, wherein the crosslinked aromatic epoxy vinyl ester polymer is essentially free of an impact modifier.

In a twelfth embodiment, the present disclosure provides a plurality of particles according to any one of the first to eleventh embodiments, wherein a particle from the plurality of particles has a density in a range from 0.6 to 1.5 grams per cubic centimeter.

In a thirteenth embodiment, the present disclosure provides a plurality of mixed particles comprising the plurality of particles according to any one of the first to twelfth embodiments and other particles.

In a fourteenth embodiment, the present disclosure provides the plurality of particles according to the thirteenth embodiment, wherein the other particles comprise at least one of sand, resin-coated sand, graded nut shells, resin-coated nut shells, sintered bauxite, particulate ceramic materials, glass beads, and particulate thermoplastic materials.

In a fifteenth embodiment, the present disclosure provides the plurality of particles according to the thirteenth embodiment, wherein the other particles comprise at least one of sand or resin-coated sand.

In a sixteenth embodiment, the present disclosure provides a fluid comprising a plurality of particles according to any one of embodiments 1 to 12 or the plurality of mixed particles according to any one of embodiments 13 to 15 dispersed therein.

In a seventeenth embodiment, the present disclosure provides a fluid according to the sixteenth embodiment, wherein the fluid comprises at least one of water, a brine, an alcohol, carbon dioxide, nitrogen gas, or a hydrocarbon.

In an eighteenth embodiment, the present disclosure provides a fluid according to the sixteenth or seventeenth embodiment, further comprising at least one of a surfactant, rheological modifier, salt, gelling agent, breaker, scale inhibitor, or dispersed gas.

In a nineteenth embodiment, the present disclosure provides a method of fracturing a subterranean geological formation penetrated by a wellbore, the method comprising:

injecting into the wellbore penetrating the subterranean geological formation a fracturing fluid at a rate and pressure sufficient to form a fracture therein; and

introducing into the fracture a plurality of particles according to any one of the first to twelfth embodiments, a plurality of mixed particles according to any one of the thirteenth to fifteenth embodiments, or a fluid according to any one of the sixteenth to eighteenth embodiments.

In a twentieth embodiment, the present disclosure provides a method according to the nineteenth embodiment, wherein injecting the fracturing fluid and introducing the plurality of particles are carried out simultaneously, and wherein the fracturing fluid comprises the plurality of particles.

In a twenty-first embodiment, the present disclosure provides a method according to the nineteenth or twentieth embodiment, wherein the fracturing is carried out at a depth of at least 500 meters.

In a twenty-second embodiment, the present disclosure provides a method of making a plurality of particles according to any one of the first to twelfth embodiments, the method comprising:

providing a mixture comprising an aromatic epoxy vinyl ester resin having at least two vinyl ester functional groups, a catalyst, and optionally an accelerator for the catalyst;

suspending the mixture in a solution comprising water to form a suspension; and

initiating crosslinking of the aromatic epoxy vinyl ester resin to make the plurality of particles.

In a twenty-third embodiment, the present disclosure provides a method according to the twenty-second embodiment, wherein the solution comprising water further comprises at least one of a cellulose polymer, gelatin, polyvinylalcohol, partially hydrolyzed polyvinyl alcohol, an acrylic acid or methacrylic acid polymer, a poly(styrene sulfonate), talc, hydroxyapatite, barium sulfate, kaolin, magnesium carbonate, magnesium hydroxide, calcium phosphate, or aluminum hydroxide as a suspending agent.

In a twenty-fourth embodiment, the present disclosure provides a method according to the twenty-second embodiment, wherein the solution comprising water is essentially free of a suspending agent.

In a twenty-fifth embodiment, the present disclosure provides a method of making a plurality of particles, the method comprising:

providing a mixture comprising an aromatic epoxy vinyl ester resin having at least two vinyl ester functional groups, a catalyst, and optionally an accelerator for the catalyst;

suspending the mixture in a solution comprising water to form a suspension, wherein the solution comprising water is essentially free of a suspending agent; and

initiating crosslinking of the aromatic epoxy vinyl ester resin to make the plurality of particles.

In a twenty-sixth embodiment, the present disclosure provides a method according to any one of the twenty-second to twenty-fifth embodiments, further comprising:

separating the plurality of particles from the solution comprising water; and

subjecting the plurality of particles to post-polymerization heating at a temperature of at least 130° C.

In a twenty-seventh embodiment, the present disclosure provides a method according to any one of the twenty-second to twenty-sixth embodiments, wherein the aromatic epoxy vinyl ester resin is a novolac epoxy vinyl ester resin.

In a twenty-eighth embodiment, the present disclosure provides a method according to any one of the twenty-second to twenty-sixth embodiments, wherein the aromatic epoxy vinyl ester resin is a bisphenol diglycidyl acrylate or methacrylate resin.

In a twenty-ninth embodiment, the present disclosure provides a method according to the twenty-eighth embodiment, wherein the aromatic epoxy vinyl ester resin is other than bisphenol-A diglycidyl methacrylate.

In a thirtieth embodiment, the present disclosure provides a method according to any one of the twenty-second to twenty-ninth embodiments, wherein the mixture further comprises at least one of a vinyl aromatic compound or a monofunctional acrylate or methacrylate.

In a thirty-first embodiment, the present disclosure provides a method according to the thirtieth embodiment, wherein the vinyl aromatic compound is styrene, and wherein the styrene is present in an amount up to 35 percent by weight, based on the total weight of the styrene and the aromatic epoxy vinyl ester resin.

In a thirty-second embodiment, the present disclosure provides a plurality of particles according to any one of the first to twelfth embodiments, wherein the plurality of particles have been subjected to post-polymerization heating at a temperature of at least 130° C.

In a thirty-third embodiment, the present disclosure provides a plurality of particles according to any one of the first to twelfth embodiments or the thirty-second embodiment, wherein the particle maintains at least 50 percent of its height under a pressure of 1.7×10⁷ Pascals up to a temperature of at least 200° C.

In order that this disclosure can be more fully understood, the following examples are set forth. It should be understood that these examples are for illustrative purposes only, and are not to be construed as limiting this disclosure in any manner.

### EXAMPLES

In these examples, all percentages, proportions and ratios are by weight unless otherwise indicated. These abbreviations are used in the following examples: g=gram, min=minutes, in =inch, m=meter, cm=centimeter, mm=millimeter, and mL=milliliter.

### Materials

“DERAKANE 470-300” is a trade designation for a Novolac epoxy-based vinyl ester resin commercially available from Ashland, Inc. Covington, Ky., with 33% styrene content.
“DERAKANE 8084” is a trade designation for an elastomer modified epoxy vinyl ester resin commercially available from Ashland with 40% styrene content.
“CoREZYN 8730” is a trade designation for a Novolac epoxy-based vinyl ester resin commercially available from Interplastic Corporation, St. Paul, Minn., with 35.4% styrene content.
“CoREZYN 8770” is a trade designation for an epoxy vinyl ester resin commercially available from Interplastic Corporation with 27% styrene content.
“CoREZYN 8300” is a trade designation for an epoxy vinyl ester resin commercially available from Interplastic Corporation that is based on methacrylated oligomers of bisphenol A and epichlorohydrin with 44.5% styrene content.
“LUPEROX A98” is a trade designation for benzoyl peroxide commercially available from Arkema, Inc., Philadelphia, Pa.
“3M GLASS BUBBLES S60HS” is a trade designation for hollow glass microspheres commercially available from 3M Company, St. Paul, Minn.
“3M CERAMIC MICROSPHERES W-610” is a trade designation for ceramic microspheres commercially available from 3M Company.
An aqueous solution of 1% poly(vinyl alcohol) with a molecular weight of M_{w}=124,000-186,000 and 87-89% hydrolyzed was commercially obtained from Sigma Aldrich, St. Louis, Mo.

### Test Methods:

### Static Compression:

A Q800 Dynamic Mechanical Analyzer (available from TA Instruments, New Castle, Del.) was used in compression mode to determine the compression resistance of single proppant particles under a static load as a function of temperature. Individual beads of each sample were placed between compression plates at room temperature. The static compressive force was ramped at 4 N/min to a force sufficient to provide 1.7×10⁷ Pascals of pressure as calculated by Pressure=Force/[(bead radius)×(bead radius)×pi)]. While holding this static force, temperature was ramped to 250° C. at a rate of 3° C./min. The sample height was indicated by the plate separation and was monitored as a function of temperature, and temperatures at which the sample height decreased to 75% and 50% of its original value were recorded.

### Swelling Evaluation:

Three beads from each sample were submerged in excess toluene and then immediately imaged with a microscope (model “SteREO Lumar V12” commercially available from Carl Zeiss, Oberkochen, Germany) to record initial diameters. The submerged samples were subsequently placed in an oven at 70° C. for 24 hours. The samples were removed from the oven and allowed to cool down to room temperature before being imaged again. The difference in diameter was used to calculate % volume increase in each sample.

### Crush Resistance:

Tensile strength testing equipment (Model “44R1123” commercially available from Instron, Norwood, Mass.) was used with a separation speed of 0.021 in/min (0.053 cm/min) and a load cell of 100 lb (45.4 kg). The tensile strength testing equipment was used in tension mode with a compression fixture, wherein a fixed top compression plate was attached to a base of the equipment and a bottom compression plate was attached to the load cell. The diameter of each bead was measured to ensure all diameters were within +/−0.0005 in (0.0012 cm) of each other. The oven was set to the pre-determined testing temperature. After the temperature had been reached, a single bead sample was placed in the center of the bottom compression plate. The plates of the compression fixture were slowly brought together until the top compression plate made contact with the bead. The distance between the compression plates was recorded as initial height (I_{H}) of the sample. The compression test was carried out by increasing the load on the sample at the specified plate separation speed. At pre-determined loads of 5 lbf (22.2 N), 10 lbf (44.5 N), 15 lbf (66.7 N), 20 lbf (89.0 N), and 25 lbf (111.2 N), the distance between the compression plates was measured and recorded as the final height (F_{H}) of the sample.

Crush Resistance (%) at a given load was calculated by the following expression:

C_{R}=(I_{H}−F_{H}/I_{H})×100 (1)

Where:

I_{H} is the initial height of the sample, and

F_{H} is the final height of the sample.

### Comparative Example 1

Commercially available proppants (trade designation “FRACBLACK” available from Sun Drilling Products Corp., Belle Chasse, La.) obtained in June 2008 are hereinafter referred to as “Comparative Example 1”.

### Comparative Example 2

Styrene-divinyl benzene beads with 5% divinyl benzene (from Anhui Sanxing, Anhui, China) were obtained and are hereinafter referred to as “Comparative Example 2”.

### Examples 1-3 and Illustrative Examples 1 and 2

The following method was used to prepare Examples 1-3 and Illustrative Examples 1 and 2: The vinyl ester resin was mixed with 1.5 wt % of benzoyl peroxide “LUPEROX A98” and stirred at room temperature until the benzoyl peroxide dissolved. A 10 gram portion of the vinyl ester resin/benzoyl peroxide solution was then mixed with 0.015 mL of N,N-dimethylaniline (Sigma-Aldrich, St. Louis, Mo.) for 25 seconds using a speedmixer (obtained from Flacktek, Inc., Landrun, S.C., under the trade designation “DAC 150 FV”) at 3000 rpm. This solution was then added to 100 mL of an aqueous solution of 1% poly(vinyl alcohol) in a glass jar. The jar was capped and purged with nitrogen. Sustained magnetic stirring was used to produce a suspension of resin droplets in the aqueous phase. The jar was placed on a hotplate at room temperature that was then ramped up to 100° C. After one hour, the temperature of the suspension was measured to be about 45° C., and the sample was removed. The resulting beads were collected by filtration and rinsed with water. They were then post cured in a 130° C. oven for 30 minutes. The vinyl ester resins used in Examples 1-3 and Illustrative Examples 1 and 2, with their respective styrene content, are shown in Table 1, below.

TABLE 1
Examples 1-3 and Illustrative Examples 1 and 2

| | | Styrene content |
|---|---|---|
| Example | Vinyl ester resin | (wt. %) |
| Example 1 | “DERAKANE 470-300” | 33 |
| Example 2 | “CoREZYN VE8730” | 34.5 |
| Example 3 | “CoREZYN VE8770” | 27 |
| Illustrative Example 1 | “DERAKANE 8084” | 40 |
| Illustrative Example 2 | “CoREZYN VE8300” | 44.5 |

Samples of Comparative Examples 1 and 2 and the beads prepared as described in Examples 1-3 and Illustrative Examples 1 and 2 were evaluated under static compression at varying temperatures according to the method described above. Temperatures at which the sample height decreased to 75% of its original value and 50% of its original value are shown in Table 2, below.

TABLE 2
Static Compression Evaluation

| | | Temperature | Temperature |
|---|---|---|---|
| | Initial Height | for 75% | for 50% |
| Example | (mm) | Height (° C.) | Height (° C.) |
| Comparative Example 1 | 0.99 | 128 | 168 |
| Comparative Example 2 | 1.00 | 96 | 107 |
| Example 1 | 0.97 | 154 | 219 |
| Example 2 | 0.99 | 142 | 208 |
| Example 3 | 1.00 | 145 | >246 |
| Illustrative Example 1 | 0.98 | 85 | 131 |
| Illustrative Example 2 | 0.96 | 94 | 112 |

Samples of Comparative Examples 1 and 2 and the beads prepared as described in Examples 1-3 and Illustrative Examples 1 and 2 were swelled in toluene according to the method described above. Percent volume increase for each example is shown in Table 3, below.

TABLE 3
Swelling Evaluation.

| Example | Volume Increase (%) |
|---|---|
| Comparative Example 1 | 71 |
| Comparative Example 2 | 80 |
| Example 1 | 3 |
| Example 2 | 5 |
| Example 3 | 16 |
| Illustrative Example 1 | 33 |
| Illustrative Example 2 | 42 |

### Examples 1a-3a and Illustrative Examples 1a and 2a

The materials and method described above for Examples 1-3 and Illustrative Examples 1 and 2 were repeated with the following modifications. A 20 gram portion of the vinyl ester resin/benzoyl peroxide solution was mixed with 0.030 mL of N,N-dimethylaniline (obtained from Sigma-Aldrich) for 60 seconds using the speedmixer at 3000 rpm. This solution was then added to 90 mL of an aqueous solution of 1% poly(vinyl alcohol) in a glass jar. The temperature of the suspension after one hour was not recorded. The particles were post cured in a 135° C. oven for 30 minutes.

Examples 1a-3a and Illustrative Examples 1a and 2a were evaluated for crush resistance at 80° C. and 120° C. according to the method described above. The results are presented in Tables 4 and 5, below. In Tables 4 and 5, “failed” indicates that the percent of the original height was 40% or less, at which point the instrument stopped collecting data.

TABLE 4
Crush resistance at 80° C.

| | Crush resistance at 80° C. | | | | | |
|---|---|---|---|---|---|---|
| | (% of Original Height) | | | | | |
| Load (lbf) | 0 | 5 | 10 | 15 | 20 | 25 |
| Comp. Example 1 | 100 | 92.5 | 73.3 | 61.3 | 55.6 | 51.2 |
| Comp. Example 2 | 100 | 86.7 | 54.4 | 45.9 | Failed | Failed |
| Example 1a | 100 | 92.5 | 80.1 | 68.6 | 63.2 | 59.6 |
| Example 2a | 100 | 92.5 | 77.6 | 66.7 | 61.5 | 57.8 |
| Example 3a | 100 | 92.7 | 82.1 | 71.2 | 65.6 | 62.0 |
| Illus. Example 1a | 100 | 69.0 | 55.8 | 50.0 | 46.3 | Failed |
| Illus. Example 2a | 100 | 81.4 | 58.7 | 51.3 | 46.8 | Failed |

TABLE 5
Crush resistance at 120° C.

| | Crush resistance at 120° C. | | | | | |
|---|---|---|---|---|---|---|
| | (% of Original Height) | | | | | |
| Load (lbf) | 0 | 5 | 10 | 15 | 20 | 25 |
| Comp. Example 1 | 100 | 73.7 | 60.0 | 54.0 | 50.4 | 46.8 |
| Example 1a | 100 | 78.3 | 67.2 | 62.3 | 59.2 | 57.0 |
| Example 2a | 100 | 76.4 | 65.3 | 60.5 | 57.5 | 55.4 |
| Example 3a | 100 | 84.3 | 71.8 | 66.3 | 63.0 | 60.6 |
| Illustrative Ex. 1a | 100 | 53.8 | 48.8 | 46.3 | Failed | Failed |
| Illustrative Ex. 2a | 100 | 47.0 | 44.4 | Failed | Failed | Failed |

### Examples 4-6

The following method was used to prepare Examples 4-6, which were vinyl ester beads with hollow glass microspheres therein. Vinyl ester resin “CoREZYN 8770” was mixed with 1.0 wt % benzoyl peroxide “LUPEROX A98” and stirred at room temperature until the benzoyl peroxide dissolved. A portion of this vinyl ester resin/benzoyl peroxide solution was then mixed with glass bubbles “3M GLASS BUBBLES S60HS” using the speedmixer at 3000 rpm in the amounts shown in Table 6. N,N-dimethylaniline was then added in an amount of 0.002 mL per gram of vinyl ester resin. This was again mixed with the speedmixer. This resin mixture was added to 100 mL of an aqueous solution of 1% poly(vinyl alcohol) in a glass jar. The jar was capped and purged with nitrogen. Sustained magnetic stirring was used to produce a suspension of resin droplets in the aqueous phase. The jar was placed on a hotplate at room temperature that was then ramped up to 130° C. After one hour, the temperature of the suspension was measured to be about 50° C., and the sample was removed. The resulting beads were collected by filtration and rinsed with water. They were then post cured in a 155° C. oven for 30 minutes. The compositions of vinyl ester particles of Examples 4-6 are shown in Table 6, below.

TABLE 6
Examples 4 to 6

| | Vinyl ester | Glass | Benzoyl | N,N-dimethyl- |
|---|---|---|---|---|
| Example | resin (g) | bubbles (g) | Peroxide (g) | aniline (mL) |
| Example 4 | 8.91 | 1 | 0.09 | 0.018 |
| Example 5 | 7.92 | 2 | 0.08 | 0.016 |
| Example 6 | 6.93 | 3 | 0.07 | 0.014 |

Example 4 was evaluated by swelling in toluene at 70° C. for 24 hours according to the method described above, and the volume increased by 12%.

### Examples 7-9

Examples 7-9 were prepared using the same method and materials as Examples 4-6 except with the modification that ceramic microspheres “3M CERAMIC MICROSPHERES W-610” were used instead of glass bubbles. The composition of the vinyl ester particles of Examples 7-9 is shown in Table 7, below. Example 7 was evaluated by swelling in toluene at 70° C. for 24 hours according to the method described above, and the volume increased by 13%.

TABLE 7
Examples 7 to 9

| | | Ceramic | | |
|---|---|---|---|---|
| | Vinyl ester | micro- | Benzoyl | N,N-dimethyl- |
| Example | resin (g) | spheres (g) | Peroxide (g) | aniline (g) |
| Example 7 | 8.91 | 1 | 0.09 | 0.018 |
| Example 8 | 7.92 | 2 | 0.08 | 0.016 |
| Example 9 | 6.93 | 3 | 0.07 | 0.014 |

Examples 1a-3a, 4-9, Comparative Example 1, and Illustrative Examples 1a and 2a were evaluated for crush resistance at 150° C. according to the test method described above. The results are shown in Table 8, below. In Table 8, “failed” indicates that the percent of the original height was 40% or less, at which point the instrument stopped collecting data.

TABLE 8
Crush resistance at 150° C.

| | Crush resistance at 150° C. | | | | | |
|---|---|---|---|---|---|---|
| | (% of Original Height) | | | | | |
| Load (lbf) | 0 | 5 | 10 | 15 | 20 | 25 |
| Comp. Example 1 | 100 | Failed | Failed | Failed | Failed | Failed |
| Illustrative Ex. 1a | 100 | 49.3 | 43.7 | Failed | Failed | Failed |
| Illustrative Ex. 2a | 100 | 44.9 | Failed | Failed | Failed | Failed |
| Example 1a | 100 | 66.9 | 60.0 | 55.2 | 54.6 | 52.8 |
| Example 2a | 100 | 63.7 | 57.4 | 54.0 | 51.7 | 50.0 |
| Example 3a | 100 | 74.5 | 66.6 | 62.4 | 59.6 | 57.5 |
| Example 4 | 100 | 83.1 | Failed | Failed | Failed | Failed |
| Example 5 | 100 | 85.3 | Failed | Failed | Failed | Failed |
| Example 6 | 100 | Failed | Failed | Failed | Failed | Failed |
| Example 7 | 100 | 84.7 | 72.9 | 67.4 | 63.9 | Failed |
| Example 8 | 100 | 78.7 | Failed | Failed | Failed | Failed |
| Example 9 | 100 | 80.6 | Failed | Failed | Failed | Failed |

Examples 4 to 9 were evaluated for static compression according to the method described above. The results are shown in Table 9, below.

TABLE 9
Static Compression Evaluation for Examples 4 to 9

| | | Temperature | Temperature |
|---|---|---|---|
| | Initial Height | for 75% | for 50% |
| Example | (mm) | Height (° C.) | Height (° C.) |
| Example 4 | 0.99 | 173 | 173 |
| Example 5 | 0.97 | 178 | 178 |
| Example 6 | 1.00 | 177 | 177 |
| Example 7 | 0.97 | 173 | 189 |
| Example 8 | 0.98 | 180 | 181 |
| Example 9 | 0.95 | 152 | 164 |

### Example 10

An aqueous solution (100 mL) of 1% poly(vinyl alcohol) in a glass jar was placed on a hot plate (RCT Basic from IKA, Wilmington, N.C.) equipped with a temperature controller (ETS-D4 from IKA). A jar lid fitted with a septum and openings for a stirring rod shaft and the temperature controller probe was placed on the jar. The solution in the jar was stirred with a VWR Power Max Dual Shaft Mixer (Model 987010) equipped with a three-blade stirring rod (blade diameter of 5 cm) while being purged with nitrogen using a needle through the septum. The temperature of the water bath was raised to 70° C. A solution of benzoyl peroxide “LUPEROX A98” (0.1 g) and N,N-dimethylaniline (0.02 mL) in 10.0 g of vinyl ester resin “CoREZYN 8770” was then added. Mechanical stirring was sustained for 30 minutes at a constant temperature of 70° C. The sample was then removed, and the resulting beads were collected by filtration and rinsed with water. They were then post cured in a 155° C. oven for 30 min. Table 10 lists the static compression evaluation results for this Example.

### Example 11

Vinyl ester beads were prepared as described in Example 10, except that the temperature of the water bath was increased to 72-75° C. Approximately 100 mL of an aqueous solution of 1% poly(vinyl alcohol) was placed in the glass jar under mechanical stirring and nitrogen purge. A solution of 2,2′-azobisisobutyronitrile (0.2 g, 98% purity, Sigma-Aldrich) in 10.0 g of vinyl ester resin “CoREZYN 8770” was then added. Mechanical stirring was sustained for 30 minutes at a constant temperature of 72° C. to 75° C. The sample was then removed, and the resulting beads were collected by filtration and rinsed with water. They were then post cured in a 155° C. oven for 30 min. Table 10 lists the static compression test results for this Example. Example 11 was evaluated by swelling in toluene at 70° C. for 24 hours according to the method described above, and the volume increased by 4%.

### Example 12

Vinyl ester beads were prepared as described in Example 10, except that the temperature of the hot bath was about 25° C. Approximately 100 mL of the aqueous solution of 1% poly(vinyl alcohol) was put in the glass jar and placed on a hot plate with mechanical stirring and nitrogen purge. A solution of benzoyl peroxide “LUPEROX A98” (0.1 g) and N,N-dimethylaniline (0.02 mL) in bisphenol A-glycidyl methacrylate (7.5 g, from 3M) and styrene (2.5 g, from Alfa Aesar) was then added. Mechanical stirring was sustained for 30 minutes while the suspension temperature was ramped to 75° C. The sample was then removed, and the resulting beads were collected by filtration and rinsed with water. They were then post cured in a 155° C. oven for 30 min. Table 10 lists the static compression test results for this Example. Example 12 was evaluated by swelling in toluene at 70° C. for 24 hours according to the method described above, and the volume increased by 5%.

### Example 13

Vinyl ester beads were prepared as described in Example 12, except that a mixture of carbon black (0.3 g, from Alfa Aesar, stock number 39724) in a solution of benzoyl peroxide “LUPEROX A98” (0.097 g) and N,N-dimethylaniline (0.019 mL) in vinyl ester resin “CoREZYN 8770” (9.6 g) was added to 100 mL of the aqueous solution of 1% poly(vinyl alcohol). Mechanical stirring was sustained for 30 minutes while the suspension temperature was ramped to 75° C. The sample was then removed, and the resulting beads were collected by filtration and rinsed with water. They were then post cured in a 155° C. oven for 30 min. Table 10 lists the static compression test results for this Example.

### Example 14

Vinyl ester beads were prepared as described in Example 12, except that a solution of benzoyl peroxide “LUPEROX A98” (0.1 g) and N,N-dimethylaniline (0.02 mL) in 10.0 g of vinyl ester resin “CoREZYN 8770” was added to 100 mL of water placed in the glass jar. Mechanical stirring was sustained for 30 minutes while the suspension temperature was ramped to 75° C. The sample was then removed, and the resulting beads were collected by filtration and rinsed with water. They were then post cured in a 155° C. oven for 30 min. Table 10 lists the static compression test results for this Example. Example 14 was evaluated by swelling in toluene at 70° C. for 24 hours according to the method described above, and the volume increased by 14%.

### Example 15

Vinyl ester beads were prepared as described in Example 12, except that a mixture of glass bubbles (“3M GLASS BUBBLES S60HS”, 0.25 g), ceramic microspheres (“3M CERAMIC MICROSPHERES W610”, 1.75 g), benzoyl peroxide “LUPEROX A98” (0.08 g) and N,N-dimethylaniline (0.016 mL) in 8.0 g of vinyl ester resin “CoREZYN 8770” was added to 100 mL of the aqueous solution of 1% poly(vinyl alcohol) placed in the glass jar. Mechanical stirring was sustained for 30 minutes while the suspension temperature was ramped to 75° C. The sample was then removed, and the resulting beads were collected by filtration and rinsed with water. They were then post cured in a 155° C. oven for 30 min. Table 10 lists the static compression test results for this Example.

### Example 16

Vinyl ester beads were prepared as described in Example 12, except that a solution of benzoyl peroxide “LUPEROX A98” (0.1 g) and N,N-dimethylaniline (0.02 mL) in 10.0 g of vinyl ester resin “CoREZYN 8770” was added to 100 mL of the aqueous solution of 1% poly(vinyl alcohol) placed in the glass jar. Mechanical stirring was sustained for 30 minutes while the suspension temperature was ramped to 90° C. The sample was then removed, and the resulting beads were collected by filtration and rinsed with water. Table 10 lists the static compression test results for this Example.

Examples 10 to 16 were evaluated for static compression according to the test method described above. The results are shown in Table 10, below.

TABLE 10
Static Compression Evaluation for Examples 10 to 16

| | | Temperature | Temperature |
|---|---|---|---|
| | Initial Height | for 75% | for 50% |
| Example | (mm) | Height (° C.) | Height (° C.) |
| Example 10 | 0.99 | 164 | 204 |
| Example 11 | 0.96 | 175 | 197 |
| Example 12 | 1.04 | 137 | 207 |
| Example 13 | 1.03 | 116 | >246 |
| Example 14 | 0.99 | 163 | >246 |
| Example 15 | 1.04 | 176 | 178 |
| Example 16 | 0.96 | 101 | >246 |

### Examples 17-27 and Illustrative Examples 3-6

N,N-dimethylaniline (in an amount of 0.04 mL) was added to a 20 g portion of a solution of 1% benzoyl peroxide “LUPEROX A98” in vinyl ester resin. The resulting solution was mixed using a speedmixer at 3000 rpm. This resin mixture was added to 100 mL of an aqueous solution of 1% poly(vinyl alcohol) in a glass jar. The jar was capped and purged with nitrogen. Sustained magnetic stirring was used to produce a suspension of resin droplets in the aqueous phase. The jar was placed on a hotplate that was ramped up to plate temperatures shown in Table 11. After 30 minutes, the sample was removed. The resulting beads were collected by filtration and rinsed with water. They were then post cured in an oven for the time and temperature indicated in Table 11.

The vinyl ester resins, the plate temperature, and the cure conditions used in Examples 17-27 and Illustrative Examples 3-6 are shown in Table 11, below. Static compression results are shown in Table 12, below. Swelling in toluene was carried out for selected examples, and the results are shown in Table 13, below.

TABLE 11
Composition and process parameters for Examples
17-27 and Illustrative Examples 3 to 6.

| | | Plate | |
|---|---|---|---|
| | | Temperature | Post Cure |
| Example | Resin | (° C.) | conditions |
| Example 17 | “DERAKANE 470-300” | 130 | 30 min at 130° C. |
| Example 18 | “DERAKANE 470-300” | 150 | 30 min at 155° C. |
| Example 19 | “DERAKANE 470-300” | 150 | 30 min at 155° C. |
| | | | 30 min at 200° C. |
| Illustrative | “DERAKANE 8084” | 150 | 30 min at 155° C. |
| Ex. 3 | | | |
| Illustrative | “DERAKANE 8084” | 150 | 30 min at 155° C. |
| Ex. 4 | | | 30 min at 200° C. |
| Example 20 | “CoREZYN VE8730” | 130 | 30 min at 130° C. |
| Example 21 | “CoREZYN VE8730” | 150 | none |
| Example 22 | “CoREZYN VE8730” | 150 | 30 min at 135° C. |
| Example 23 | “CoREZYN VE8730” | 150 | 30 min at 155° C. |
| Example 24 | “CoREZYN VE8730” | 150 | 30 min at 155° C. |
| | | | 60 min at 210° C. |
| Example 25 | “CoREZYN VE8770” | 130 | 30 min at 130° C. |
| Example 26 | “CoREZYN VE8770” | 150 | 30 min at 155° C. |
| Example 27 | “CoREZYN VE8770” | 150 | 30 min at 155° C. |
| | | | 30 min at 200° C. |
| Illustrative | “CoREZYN VE8300” | 150 | 30 min at 155° C. |
| Ex. 5 | | | |
| Illustrative | “CoREZYN VE8300” | 150 | 30 min at 155° C. |
| Ex. 6 | | | 30 min at 200° C. |

TABLE 12
Static compression evaluation.

| | | Temperature | Temperature |
|---|---|---|---|
| | Initial Height | for 75% | for 50% |
| Example | (mm) | Height (° C.) | Height (° C.) |
| Example 17 | 0.97 | 150 | 197 |
| Example 18 | 0.96 | 158 | >246 |
| Example 19 | 0.99 | 166 | >246 |
| Illustrative Ex. 3 | 1.01 | 95 | 133 |
| Illustrative Ex. 4 | 0.97 | 98 | 141 |
| Example 20 | 1.01 | 155 | >246 |
| Example 21 | 0.96 | 62 | >246 |
| Example 22 | 0.97 | 142 | >246 |
| Example 23 | 1.04 | 157 | 239 |
| Example 24 | 0.96 | 165 | >246 |
| Example 25 | 1.00 | 167 | >246 |
| Example 26 | 0.97 | 154 | >246 |
| Example 27 | 0.97 | 173 | >246 |
| Illustrative Ex. 5 | 0.97 | 101 | 118 |
| Illustrative Ex. 6 | 1.03 | 115 | 132 |

TABLE 13
Swelling Evaluation.

| Example | Volume Increase (%) |
|---|---|
| Example 17 | 5 |
| Example 19 | 6 |
| Illustrative Example 4 | 60 |
| Example 21 | 10 |
| Illustrative Example 6 | 46 |

### Illustrative Examples 8-10

Solutions of benzoyl peroxide “LUPEROX A98”, vinyl ester resin “DERAKANE 470-300”, and additional styrene (commercially available from Alfa Aesar) were prepared in varying amounts. The total styrene content in these solutions was determined by both the styrene originally provided in the resin and the added styrene. N,N-dimethylaniline (in an amount of 0.02 mL) was mixed with the solution and added to 100 mL of an aqueous solution of 1% poly(vinyl alcohol) in a glass jar. The jar was capped and purged with nitrogen. Sustained magnetic stirring was used to produce a suspension of resin droplets in the aqueous phase. The jar was placed on a hotplate that was ramped to a plate temperature of 150° C. After 30 minutes, the sample was removed. The resulting beads were collected by filtration and rinsed with water. They were then post cured for 30 min in a 155° C. oven. Compositions used for preparing Illustrative Examples 8-10 are shown in Table 14, below.

TABLE 14
Illustrative Examples 8 to 10

| | Vinyl | | Benzoyl | Total |
|---|---|---|---|---|
| | Ester | Styrene | peroxide | Styrene |
| Example | Resin (g) | (g) | (g) | Content (g) |
| Illustrative Example 8 | 7.92 | 1.98 | 0.1 | 46% |
| Illustrative Example 9 | 5.94 | 3.96 | 0.1 | 59% |
| Illustrative Example 10 | 3.96 | 5.94 | 0.1 | 72% |

Illustrative Example 8 was evaluated by swelling in toluene at 70° C. for 24 hours according to the method described above, and the volume increased by 27%. Static compression results for Illustrative Examples 8-10 are shown in Table 15, below.

TABLE 15
Static Compression Results

| | | Temperature | Temperature |
|---|---|---|---|
| | Initial Height | for 75% | for 50% |
| Example | (mm) | Height (° C.) | Height (° C.) |
| Illustrative Example 8 | 1.02 | 132 | 234 |
| Illustrative Example 9 | 1.04 | 117 | 161 |
| Illustrative Example 10 | 0.99 | 104 | 140 |

### Comparative Example 3

Comparative Example 3 was prepared as a replicate of Example 4 in U.S. Pat. No. 4,398,003 (Irwin). Vinyl Ester Resin “DERAKANE 470-300” (42.98 g) was mixed with styrene (2.02 g) to bring the total styrene content up to 36% by weight. This solution was then mixed with benzoyl peroxide “LUPEROX A98” (0.5 g), plasticizer (0.5 g) obtained from Ferro Corporation, Cleveland, Ohio, under the trade designation “SANTICIZER 261A”, and montmorillonite clay (5 g from Sigma-Aldrich, Catalog #281530). This mixture was added to 100 mL of an aqueous solution of 1% poly(vinyl alcohol) in a glass jar. The contents of the jar were mechanically stirred at 23° C. while being purged with nitrogen. After 10 minutes, 0.10 mL of N,N-dimethylaniline was added. After 30 minutes, the temperature of the PVA solution was heated to 30° C. The temperature then exothermed to a peak of 36° C., and the reaction was stopped. The resulting beads were collected by filtration and rinsed with water. They were post cured in a 110° C. oven for 60 min. Upon static compression of a 1.01 mm bead with 13.34 N of force, the bead reached 75% of its original height at 121° C. and reached 50% of its original height at 167° C. Upon swelling in toluene at 70° C. for 24 hours, the volume increased by 2%.

### Example 28

Vinyl Ester Resin “DERAKANE 470-300” (28.65 g) was mixed with styrene (1.35 g) to bring the total styrene content up to 36% by weight, and 0.3 g of benzoyl peroxide “LUPEROX A98” was added. A mixture of this solution (9.0 g) was mixed with montmorillonite clay (1.0 g from Sigma Aldrich, Catalog #281530). This mixture was added to 100 mL of an aqueous solution of 2% poly(vinyl alcohol) in a glass jar. The contents of the jar were mechanically stirred at 55° C. while being purged with nitrogen. After 10 minutes, 0.018 mL of N,N-dimethylaniline was added. After 30 minutes at 55° C., the resulting beads were collected by filtration and rinsed with water. They were post cured in a 155° C. oven for 30 min. Upon static compression of a 1.00 mm bead with 13.34 N of force, the bead reached 75% of its original height at 164° C. and reached 50% of its original height at 182° C. Upon swelling in toluene at 70° C. for 24 hours, the volume increased by less than 1%.

### Example 29

Bisphenol A-glycidyl methacrylate (4.95 g, obtained from 3M Company) was mixed with benzoyl peroxide “LUPEROX A98” (0.05 g). This solution was added to 100 mL of an aqueous solution of 2% poly(vinyl alcohol) in a glass jar. The contents of the jar were mechanically stirred at 55° C. while being purged with nitrogen. After 10 minutes, 0.010 mL of N,N-dimethylaniline was added. After 30 minutes at 55° C., the resulting beads were collected by filtration and rinsed with water. They were post cured in a 155° C. oven for 30 minutes. Upon static compression of a 1.00 mm bead with 13.34 N of force, the bead reached 75% of its original height at 195° C. and reached 50% of its original height at 212° C. Upon swelling in toluene at 70° C. for 24 hours, the volume increased by 2%.

### Example 30

Approximately 300 mL of an aqueous solution of 1% poly(vinyl alcohol) were placed in a jacketed glass reactor. Nitrogen gas was purged through the reactor headspace. A 60° C. solution of ethylene glycol in water was circulated through the reactor jacket. The solution in the jar was stirred with a mixer equipped with a paddle stirrer. Benzoyl peroxide “LUPEROX A98” (1 wt % relative to the weight of vinyl ester resin) was dissolved in 40 grams of a bisphenol A epoxy vinyl ester resin with 24% to 30% styrene content obtained from Huachang Polymer, Shanghai, China, under the trade designation “MFE-10”. N,N-dimethylaniline (0.15 wt % relative to the vinyl ester resin) was added to the reactor followed by immediate addition of the vinyl ester resin mixture. Mechanical stirring was sustained for one hour. The resulting beads were collected by filtration and rinsed with water. The beads were then post-cured in an oven set at 155° C. for 30 min. Upon static compression of a 0.91 mm bead using the test method described above, the bead reached 75% of its original height at 135° C. and reached 50% of its original height at greater than 246° C. Upon swelling in toluene at 70° C. for 24 hours, the volume increased by 9.7%.

This disclosure may take on various modifications and alterations without departing from its spirit and scope. Accordingly, this disclosure is not limited to the above-described embodiments but is to be controlled by the limitations set forth in the following claims and any equivalents thereof. This disclosure may be suitably practiced in the absence of any element not specifically disclosed herein.

1. A plurality of polymer particles comprising a crosslinked aromatic epoxy vinyl ester polymer essentially free of inorganic filler, wherein a particle from the plurality of particles swells not more than 20 percent by volume when submerged in toluene for 24 hours at 70° C.

2. A plurality of polymer particles comprising a crosslinked aromatic epoxy vinyl ester polymer, wherein a particle from the plurality of particles maintains at least 75 percent of its height under a pressure of 1.7×10⁷ Pascals up to at least 135° C.

3. A plurality of polymer particles according to claim 2, wherein the particle swells not more than 20 percent by volume when submerged in toluene for 24 hours at 70° C.

4. A plurality of polymer particles according to claim 2, wherein the particle maintains 50 percent of its height under a pressure of 1.7×10⁷ Pascals up to a second temperature that is at least twenty percent higher than a first temperature, wherein the first temperature is the temperature up to which the particle maintains 75 percent of its height.

5. A plurality of polymer particles according to claim 2, wherein the crosslinked aromatic epoxy vinyl ester polymer is a novolac epoxy vinyl ester polymer.

6. A plurality of polymer particles according to claim 2, wherein the crosslinked aromatic epoxy vinyl ester polymer is a bisphenol diglycidyl acrylic or methacrylic polymer.

7. A plurality of polymer particles according to claim 2, wherein the crosslinked aromatic epoxy vinyl ester polymer is a copolymer of an aromatic epoxy vinyl ester and at least one of a vinyl aromatic compound or a monofunctional acrylate or methacrylate.

8. A plurality of polymer particles according to claim 7, wherein the crosslinked aromatic epoxy vinyl ester polymer is a copolymer of an aromatic epoxy vinyl ester and styrene, wherein the styrene is present in an amount up to 35 percent by weight, based on the total weight of the copolymer.

9. A plurality of polymer particles according to claim 2, further comprising at least one of glass microbubbles, glass microspheres, silica, calcium carbonate, ceramic microspheres, aluminum silicate, carbon black, mica, micaceous iron oxide, aluminum oxide, or feldspar dispersed within the crosslinked aromatic epoxy vinyl ester polymer.

10. A plurality of polymer particles according to claim 1, wherein the crosslinked aromatic epoxy vinyl ester polymer is essentially free of an impact modifier.

11. A plurality of mixed particles comprising the plurality of polymer particles according to claim 1 and other particles comprising at least one of sand, resin-coated sand, graded nut shells, resin-coated nut shells, sintered bauxite, particulate ceramic materials, glass beads, and particulate thermoplastic materials.

12. A fluid comprising a plurality of polymer particles according to claim 1 dispersed therein, wherein the fluid comprises at least one of water, a brine, an alcohol, carbon dioxide, nitrogen gas, or a hydrocarbon.

13. A method of fracturing a subterranean geological formation penetrated by a wellbore, the method comprising:
injecting into the wellbore penetrating the subterranean geological formation a fracturing fluid at a rate and pressure sufficient to form a fracture therein; and
introducing into the fracture a plurality of polymer particles according to claim 1.

14. A method of making a plurality of polymer particles according to claim 1, the method comprising:
providing a mixture comprising an aromatic epoxy vinyl ester resin having at least two vinyl ester functional groups, a catalyst, and optionally an accelerator for the catalyst;
suspending the mixture in a solution comprising water to form a suspension; and
initiating crosslinking of the aromatic epoxy vinyl ester resin to make the plurality of polymer particles.

15. A method of making a plurality of particles, the method comprising:
providing a mixture comprising an aromatic epoxy vinyl ester resin having at least two vinyl ester functional groups, a catalyst, and optionally an accelerator for the catalyst;
suspending the mixture in a solution comprising water to form a suspension, wherein the solution comprising water is essentially free of a suspending agent; and
initiating crosslinking of the aromatic epoxy vinyl ester resin to make the plurality of particles.

16. A method according to claim 14, further comprising:
separating the plurality of polymer particles from the solution comprising water; and
subjecting the plurality of polymer particles to post-polymerization heating at a temperature of at least 130° C.

17. A plurality of polymer particles according to claim 1, wherein the crosslinked aromatic epoxy vinyl ester polymer is a novolac epoxy vinyl ester polymer.

18. A plurality of polymer particles according to claim 1, wherein the crosslinked aromatic epoxy vinyl ester polymer is a bisphenol diglycidyl acrylic or methacrylic polymer.

19. A plurality of polymer particles according to claim 1, wherein the crosslinked aromatic epoxy vinyl ester polymer is a copolymer of an aromatic epoxy vinyl ester and at least one of a vinyl aromatic compound or a monofunctional acrylate or methacrylate.

20. A plurality of polymer particles according to claim 19, wherein the crosslinked aromatic epoxy vinyl ester polymer is a copolymer of an aromatic epoxy vinyl ester and styrene, wherein the styrene is present in an amount up to 35 percent by weight, based on the total weight of the copolymer.
